(19) United States
(12) Patent Application Publication
(10) Pub. No.: US 2009/0152831 A1
(43) Pub. Date: Jun. 18, 2009

(54) HITCHING DEVICE WITH STABILIZER FOR AVOIDING AND/OR DAMPING ROLLING MOTIONS BETWEEN A TRACTION VEHICLE AND A TRAILER COUPLED TO THIS TRACTION VEHICLE

(76) Inventor: Armin Verhagen, Schwieberdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/274,684

(22) Filed: Nov. 20, 2008

(30) Foreign Application Priority Data
Dec. 12, 2007 (DE) 10 2007 059 900.7

(51) Int. Cl. B60D 1/32

(52) U.S. Cl. 280/455.1

(57) ABSTRACT

The invention is based on a hitching device with a stabilizer for avoiding and/or damping rolling motions between a traction vehicle and a trailer coupled to it. The stabilizer is equipped with a friction clutch, which affects the friction conditions between a trailer hitch on the end toward the traction vehicle and a coupling element on the end toward the trailer. According to the invention, the stabilizer is provided with an externally triggerable electric motor and a gear acted upon by the electric motor be used for actuating the fiction clutch. The gear is self-locking in the release direction of the stabilizer.

### CROSS-REFERENCE TO RELATED APPLICATIONS

This application is based on German Patent Application No. 10 2007 059 900.7 filed on Dec. 12, 2007, upon which priority is claimed.

### BACKGROUND OF THE INVENTION

1. Field of the Invention

The invention is based on a hitching device with a stabilizer for avoiding and/or damping rolling motions between a traction vehicle and a trailer coupled to this traction device.

2. Description of the Prior Art

One such hitching device with a stabilizer is already known from German Utility Model DE 20316698 U1, for example. This stabilizer is secured to a tow bar of a trailer. It has a pair of friction brake linings, which in the coupled state of the trailer are pressed against a trailer hitch on the end toward the traction vehicle. The tightening force at any given time is brought to bear mechanically or by hydraulic pressure. Because of the adjustability of the tightening force, the friction conditions between the traction vehicle and the trailer can be defined once and for all upon hitching.

German Patent Disclosure DE 3702699 A1 likewise discloses mechanical, pneumatic or hydraulic means for exerting the tightening force and moreover suggests adjusting these tightening forces as a function of the travel speed of the traction vehicle and/or of the total weight of the trailer load.

However, stabilizers acted upon hydraulically and pneumatically have the disadvantage that to maintain the tightening forces during travel, system pressure must be constantly available, so that accordingly such systems are dependent on a permanent supply of energy. Moreover, stabilizers acted upon hydraulically or pneumatically can be economically used only with trailers that are already equipped with a hydraulic or pneumatic trailer brake. However, since a majority of trailers are equipped with mechanical trailer brake systems, these trailers are not readily suited for the use of stabilizers that are actuatable hydraulically or pneumatically.

Mechanically actuated stabilizers, by comparison, have the advantage of a more-economical construction. However, for the driver, manipulating them involves physical exertion and is therefore perceived as uncomfortable. In stabilizer systems that operate mechanically, only unsatisfactory adaptation of the tightening forces to the travel conditions at that time has been possible, until now.

### OBJECT AND SUMMARY OF THE INVENTION

By comparison, a hitching device with a stabilizer according to the invention has the advantage that actuating the stabilizer is done by an electric motor having a downstream gear. The gear has self-locking in the release direction of the stabilizer. Thus energy has to be exerted only to close the stabilizer, or in other words to increase the tightening force, but not for maintaining the tightening force once established. Unintentional release of the stabilizer is avoided by the self-locking.

Stabilizers actuatable by electric motor can be operated without expending physical force, by a manually actuatable user control element. Hence the comfort of hitching a trailer to a traction vehicle can be improved, making even persons with relatively little physical strength also capable of performing the hitching operation.

In addition, stabilizers that can be actuated by an electric motor can be incorporated relatively simply into an electronic control or regulating circuit. From sensors known per se, parameters that describe the travel state of a group comprising a traction vehicle and a trailer are simply ascertained and delivered to an electronic control unit. Without extensive sensors, a conclusion can be drawn as to the tightening force of the stabilizer prevailing at that time, based on the current flowing to the electric motor. By use of the electronic control unit, from its signals, trigger signals can be generated that permit an adaptation of the tightening force of a stabilizer to the travel states of a group during ongoing travel.

Moreover, stabilizers actuated by electric motor are suitable for retrofitting trailers that until now had no stabilizer at all. There are no limitations on the type of trailer brake system, since all mass-produced trailers are already connectable to the electric power supply of the traction vehicle, for instance for operating their lighting system.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a schematically highly simplified side view, showing a hitching device with an electromechanical stabilizer; and

FIG. 2 shows a top view of a first embodiment of gears for actuating the electromechanical stabilizers according to the invention.

FIG. 3 shows a top view of a second embodiment of gears for actuating the electromechanical stabilizers according to the invention.

FIG. 4 shows a top view of a third embodiment of gears for actuating the electromechanical stabilizers according to the invention.

### DESCRIPTION OF THE PREFERRED EMBODIMENTS

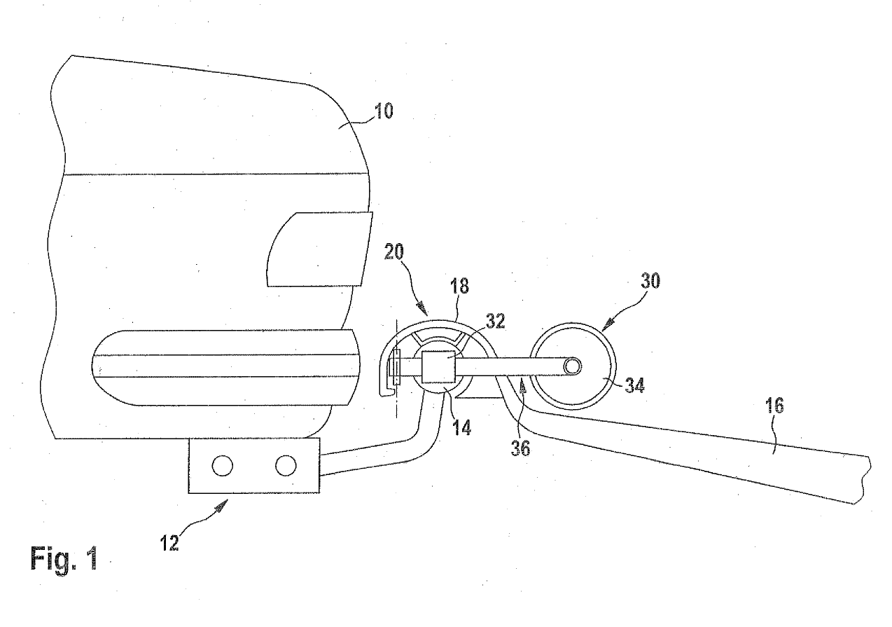

FIG. 1 shows the back end of a traction vehicle 10, with a trailer hitch 12 anchored to it. This trailer hitch 12 is designed in conventional form and on its free end has a ball head 14. A coupling element 18, attached to a tow bar 16 of a trailer, not shown, cooperates with this ball head 14. The coupling element 18 is embodied in simplified form as a ball-shaped dome that is open at the bottom and to the sides and that from above fits over onto the ball head 14 of the trailer hitch 12 of the vehicle. The trailer hitch 12 and the coupling element 18 together form a hitching device 20, which according to the invention is equipped with a stabilizer 30 that can be actuated by an electric motor. The stabilizer includes a friction clutch with friction brake linings 32 that act on the ball head 14 of the trailer hitch 12. An electric motor 34 is provided for adjusting the tightening force with which the friction brake linings 32 are pressed against the ball head 14. The electric motor 34 actuates the friction brake linings 32 via a downstream gear 36.

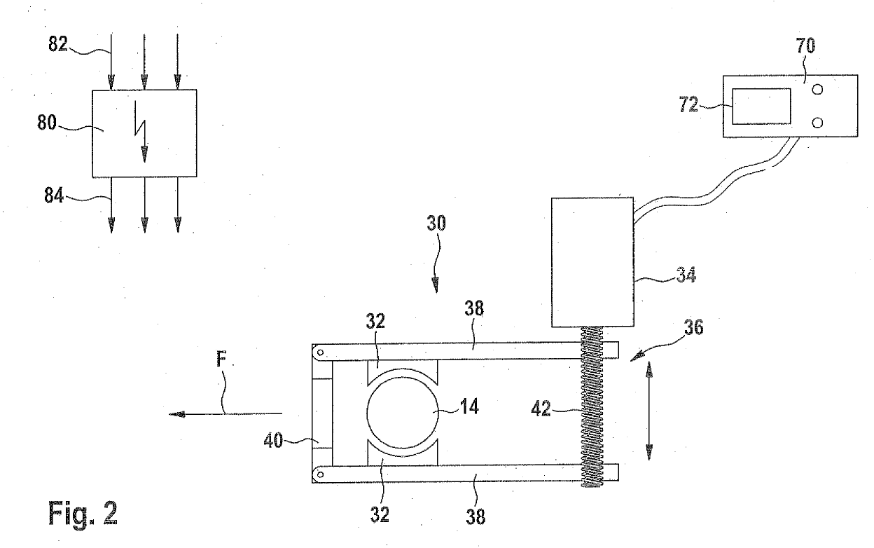

FIG. 2 shows a stabilizer 30 according to a first embodiment of the invention, which is actuated by an electric motor 34 and whose friction clutch has friction brake linings 32 that are secured to two parallel, horizontally extending brake levers 38. The brake levers 38 are disposed on diametrically opposed sides of the ball head 14 and extend in the travel direction F of the traction vehicle 10. On their first ends, oriented toward the traction vehicle 10, the two brake levers 38 are connected in articulated fashion to a cross-arm 40. This cross-arm is located between the traction vehicle 10 and the ball head 14 and extends transversely to the travel direction F. The gear 36 of the stabilizer 30 furthermore includes a threaded spindle 42 that can be driven by the electric motor 34. The brake levers 38, coupled to one another via the cross-arm 40, can be spread apart or clamped as a function of the direction of rotation of this threaded spindle 42. For that purpose, the threaded spindle 42 is disposed on the side of the ball head 14 diametrically opposite the cross-arm 40 and are likewise oriented transversely to the travel direction F of the vehicle 10. The operative connection between the brake levers 38 and the threaded spindle 42 can be attained for instance by way of a threaded set of teeth with different pitch directions or can also be attained by means of a rotatable positional fixation of the threaded spindle 42 to one of the brake levers 38, in combination with a threaded set of teeth between the threaded spindle 42 and the respective other brake lever 38. The tooth geometry is designed such that the gear 36 has self-locking in the release direction.

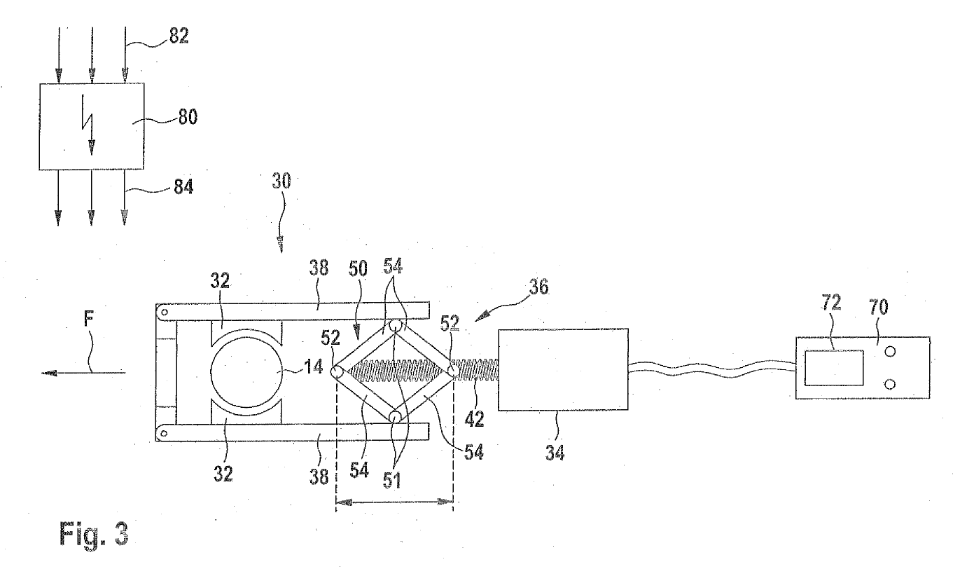

In the second exemplary embodiment of FIG. 3, the stabilizer 30 that is actuated by electric motor has a threaded spindle 42, which is driven by an electric motor 34 and is oriented in the travel direction F of the vehicle 10. This threaded spindle 42 now actuates a gear 36, in the form of a scissors drive 50 comprising a total of four joints 51, 52 and four scissor blades 54. Each of the scissor blades 54 connects two joints 51, 52 movably relative to one another. The two joints 51 are disposed in stationary fashion at diametrically opposed points of two brake levers 38 that have function brake linings 32, while the other two joints 52 are disposed axially movably on the threaded spindle 42, for instance by means of threaded bushes. The threaded bushes of the joints 52 cooperate with the threaded spindle 42 for instance via sets of threaded teeth with different pitch directions, and as a result can move toward or away from one another as a function of the direction of rotation of the threaded spindle 42. Upon a motion of the joints 52 on the threaded spindle 42, the spacing between them changes, and the friction brake linings 32 are pressed against the ball head 14 with increasing or decreasing tightening force.

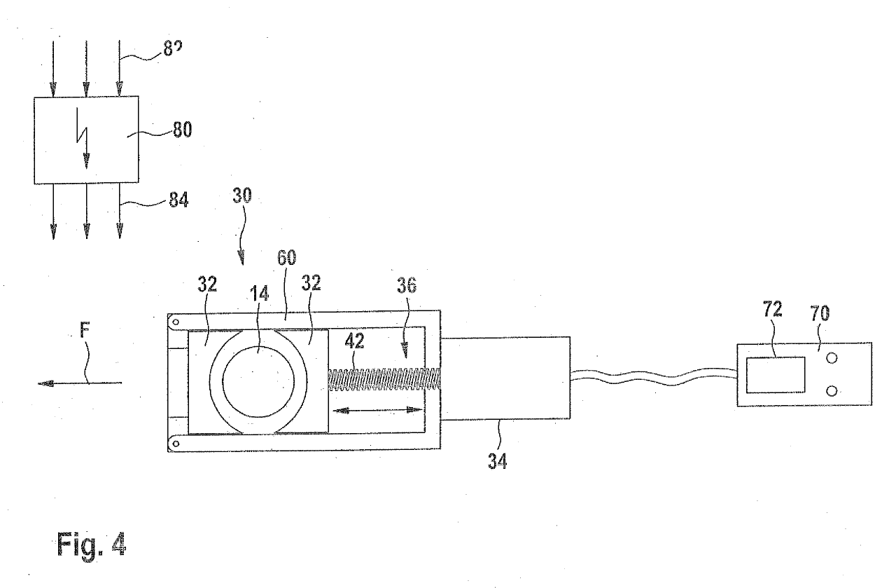

The third exemplary embodiment of FIG. 4 has a stabilizer 30, actuated by electric motor, with a movably disposed floating frame 60. This floating frame 60 is rectangular, for example, and in spaced-apart fashion surrounds the ball head 14 of a trailer hitch 12 on the end toward the traction vehicle. The electric motor 34 is solidly anchored to the floating frame 60. The gear 36 driven by the electric motor 34 comprises a threaded spindle 42, which is extended through an opening on one face end of the floating frame 60 and on which a first friction brake lining 32 is movably disposed. This friction brake lining 32 is guided laterally inside the floating frame 60, so that the friction brake lining 32, as a result of the rotary motion of the threaded spindle 42, executes an axial translational motion in or counter to the travel direction F of a vehicle 10. The direction of motion is effected as a function of the direction of rotation of the threaded spindle 42. As soon as the first friction brake lining 32 meets the ball head 14 of the trailer hitch 12, the floating frame 60, because of the reaction force, executes an axial motion counter to the travel direction F. This axial motion ends as soon as a second friction brake lining 32, diametrically opposite the first friction brake lining 32, also meets the ball head 14. With this gear construction, the electric motor 34, threaded spindle 42 and friction brake linings 32 are oriented coaxially to one another in the travel direction F of the vehicle 10.

All the stabilizers 30 described function in such a way that upon a change in the direction of rotation of the electric motor 34, the stabilizer 30 can be tightened or released. In the tightening direction, friction brake linings 32 are pressed with increasing tightening force against the ball head 14 of a trailer hitch 12, and the forces of friction between this trailer hitch 12 and a coupling element 18 are thus increased. Conversely, these fiction conditions can be lessened by driving the stabilizer 30 in the release direction.

The invention is not limited to the threaded spindle drives described. Other constructions of gears can equally be imagined, such as worm gears or gear wheel/rack drives. All these types of gears can be designed, in a manner known to one skilled in the art, by the selection of their toothing geometries, in such a way that they have self-locking in the release direction. As a result, the function conditions, once established, cannot vary automatically, or in other words not without the electrical triggering of the electric motor 34.

For furnishing a trigger signal for the electric motor 34, a user control element 70 that is actuatable manually by the driver can be provided, for instance in the form of an electromechanical key or switch. Thus the stabilizer 30, when a trailer is being hitched, can be actuated comfortably without the expenditure of force. For showing the established state of tightening of the stabilizer 30, a display instrument 72 may additionally be provided.

In a dismantling step, it is possible to control the stabilizer 30 as a function of parameters, or in other words to vary the tightening force of the stabilizer 30 as a function of the varying group speed during travel. For that purpose, an electronic control unit 80 would have to be provided that detects signals 82 which represent the group speed and which evaluates these arriving signals 82 for trigger signals 84 for the electric motor 34 of the stabilizer 30.

It is also possible, for instance by detecting transverse accelerations or yawing moments occurring at the traction vehicle 10 and/or at the trailer, by the electronic control unit 80 during travel to design the described stabilizer 30 as an automatic group stabilizing system, in which the established tightening forces are regulated in accordance with these measured parameters. A conclusion about the friction conditions at that time between a trailer hitch 12 and a coupling element 18 can easily be drawn by way of the current consumed by the electric motor 34.

It is understood that refinements or additions to the exemplary embodiments described are conceivable without departing from the fundamental concept of the invention.

Stabilizers 30 actuatable by electric motor for instance also allow direct monitoring of the friction conditions between a trailer hitch 12 and a coupling element 18 and can be controlled or regulated as a function of the values ascertained. The prevailing friction conditions can for instance be ascertained by force sensors, which detect the incident shear forces between the brake levers 38 and the brake linings 32 secured to them, and send signals to the electronic control unit 80 to be evaluated. Temperature fluctuations can also be compensated for on the basis of temperature models stored in memory in the electronic control unit 80.

The foregoing relates to preferred exemplary embodiments of the invention, it being understood that other variants and embodiments thereof are possible within the spirit and scope of the invention, the latter being defined by the appended claims.

I claim:

1. A hitching device with a stabilizer, for preventing and/or damping rolling motions between a traction vehicle and a trailer coupled to it, comprising:
a trailer hitch attached to the traction vehicle;
a coupling element that can be disposed on the trailer and brought into operative connection with the trailer hitch; and
an externally actuatable stabilizer that affects friction conditions between the trailer hitch and the coupling element, the stabilizer including an externally triggerable electric motor and a gear, driven by the electric motor and thereby actuating the stabilizer, wherein the gear is self-locking in a release direction of the stabilizer.

2. The hitching device as defined by claim 1, further comprising a manually actuatable user control element for generating an electronic trigger signal for the electric motor.

3. The hitching device as defined by claim 1, further comprising an electronic control unit for controlling or regulating triggering of the electric motor during travel.

4. The hitching device as defined by claim 2, further comprising an electronic control unit for controlling or regulating triggering of the electric motor during travel.

5. The hitching device as defined by claim 3, wherein the electronic control unit detects the travel speed, for instance, and/or transverse accelerations or yawing moments engaging the traction vehicle and/or the trailer, and a current flowing to the electric motor and evaluates those parameters for trigger signals.

6. The hitching device as defined by claim 4, wherein the electronic control unit detects the travel speed, for instance, and/or transverse accelerations or yawing moments engaging the traction vehicle and/or the trailer, and a current flowing to the electric motor and evaluates those parameters for trigger signals.

7. The hitching device as defined by claim 1, further comprising an electronic control unit for controlling or regulating triggering of the electric motor during travel.

8. The hitching device as defined by claim 2, further comprising an electronic control unit for controlling or regulating triggering of the electric motor during travel.

9. The hitching device as defined by claim 3, further comprising an electronic control unit for controlling or regulating triggering of the electric motor during travel.

10. The hitching device as defined by claim 5, further comprising an electronic control unit for controlling or regulating triggering of the electric motor during travel.

11. The hitching device as defined by claim 1, wherein the gear includes a spindle drive with at least one threaded spindle that is drivable by the electric motor.

12. The hitching device as defined by claim 2, wherein the gear includes a spindle drive with at least one threaded spindle that is drivable by the electric motor.

13. The hitching device as defined by claim 3, wherein the gear includes a spindle drive with at least one threaded spindle that is drivable by the electric motor.

14. The hitching device as defined by claim 5, wherein the gear includes a spindle drive with at least one threaded spindle that is drivable by the electric motor.

15. The hitching device as defined by claim 7, wherein the gear includes a spindle drive with at least one threaded spindle that is drivable by the electric motor.

16. The hitching device as defined by claim 1I, wherein the spindle drive actuates brake levers that have friction brake linings and are connected in articulated fashion to a cross-arm.

17. The hitching device as defined by claim 12, wherein the spindle drive actuates brake levers that have friction brake linings and are connected in articulated fashion to a cross-arm.

18. The hitching device as defined by claim 15, wherein the spindle drive actuates brake levers that have friction brake linings and are connected in articulated fashion to a cross-arm.

19. The hitching device as defined by claim 11, wherein the spindle drive actuates at least one brake lining that is guided displaceably in a floating frame.

20. The hitching device as defined by claim 15, wherein the spindle drive actuates at least one brake lining that is guided displaceably in a floating frame.
